(19) United States
(12) Patent Application Publication
(10) Pub. No.: US 2009/0136816 A1
(43) Pub. Date: May 28, 2009

(54) HOLLOW CAPSULE STRUCTURE AND METHOD OF PREPARING THE SAME

(75) Inventors: Soon-ki Kang, Suwon-si (KR); Geun-Seok Chai, Suwon-si (KR); Myoung-Ki Min, Suwon-si (KR); Chan Kwak, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/324,068

(22) Filed: Nov. 26, 2008

(30) Foreign Application Priority Data
Nov. 28, 2007 (KR) 10-2007-0122150

(51) Int. Cl. H01M 8/10; H01M 4/88; B01J 23/00; B01J 31/06

(52) U.S. Cl. 429/30; 428/34.1; 502/101; 502/300; 502/159; 502/180

(57) ABSTRACT

A hollow capsule structure and a method of preparing the same are disclosed. The hollow capsule structure may include a shell with nanopores. The nanopores may be spherical nanopores. The hollow capsule structure may include pores connected to one another with excellent electronic conductivity and a large specific surface area. In addition, the hollow capsule structure may be configured to can easily transfer mass due to a capillary phenomenon of the nanopores in the shell. As a result, the hollow capsule structure may be configured for use with a catalyst supporter, a supporter for growing carbon nanotubes, an active material, a conductive agent, a separator, a deodorizer, a purifier, an adsorption agent, a material for a display emitter layer, a filter and the like.

### CROSS-REFERENCE TO RELATED APPLICATIONS

This application is a non-provisional application, which claims priority to and the benefit of Korean Patent Application No. 10-2007-0122150 filed in the Korean Intellectual Property Office on Nov. 28, 2007, the entire content of which is hereby incorporated by reference.

### BACKGROUND

1. Field of the Invention

The present invention relates to a hollow capsule structure and a method of preparing the same. More particularly, the present invention relates to a hollow capsule structure that has good electronic conductivity and a large specific surface area and that easily performs mass transfer, and a method of preparing the same.

2. Description of the Related Technology

In general, a porous material can be applied to a catalyst carrier, a separation system, a low dielectric constant material, a hydrogen storage material, photonics crystal, and the like. The porous material may include an inorganic material, a metal, a polymer or carbon. The carbon material has excellent chemical and mechanical characteristics and thermal stability, and thus can be usefully applied to various areas. In particular, a porous carbon material of various kinds and shapes may be widely used in fuel cells because it has excellent surface, ion conductivity, and anti-corrosion characteristics as well as a low cost. For example, the porous carbon material may include activated carbon and carbon black used as a catalyst carrier. Currently, carbon black or Vulcan XC-72 is used as a carrier for an electrode catalyst of a fuel cell and one commercially-available E-TCK catalyst is a Pt—Ru alloy catalyst supported by the Vulcan XC-72.

Recently, other types of carbon materials, for example, meso-structured carbon, graphitic carbon nanofiber, and mesocarbon microbeads, have been widely used as catalyst supporters to enhance activity of a metal catalyst. It is still difficult, however, to synthesize a porous carbon material with a large specific surface area and a mutually-connected structure.

Recently, a template has been used in one of the most popular methods of synthesizing a porous carbon material with a regularly-arranged structure by using zeolite, a mesoporous material and colloidal crystal. According to this synthesis method, a porous carbon material is prepared by injecting a carbon precursor into a porous silica mold, carbonizing the carbon precursor under a non-oxidation condition and dissolving the silica mold in a HF or NaOH solution. Although this method may succeed in producing a carbon material with a single pore size, it has a limit in increasing its specific surface area. Thus, additional research has been required to achieve a porous carbon material with both a larger specific surface area and a mutually-connected structure.

### SUMMARY OF CERTAIN INVENTIVE ASPECTS

In one aspect a hollow capsule structure comprises good electrical conductivity and a large specific surface area, the hollow capsule structure configured to perform mass transfer.

In one aspect a hollow capsule structure comprises a shell having spherical nanopores therein. In some embodiments a nanopore diameter ranges from about 5 nm to about 100 nm.

In some embodiments a hollow macropore has a macropore diameter ranging from about 100 nm to about 5 μm. In some embodiments a ratio of the nanopore diameter and the hollow macropore diameter is from about 1:1 to about 1:200. In some embodiments the shell further comprises a void with a void diameter of about 90% to about 95% of that of a nanopore. In some embodiments a hollow capsule structure has a surface area ranging from about 500 m²/g to about 2000 m²/g. In some embodiments a hollow capsule structure includes a material selected from the group consisting of carbon, a polymer and an inorganic metal oxide. In some embodiments the hollow capsule structure can be applied for a catalyst supporter, a supporter for carbon nanotube growth, an active material, a conductive agent, a separator, a deodorizer, a purifier, an adsorption agent, a material for a display emitter layer, and a filter.

In another aspect a fuel cell catalyst have a hollow capsule structure including a shell having nanopores therein and an active material disposed on the hollow capsule structure.

In some embodiments the nanopores include spherical nanopores. In some embodiments the nanopores have a nanopore diameter ranging from about 5 nm to about 100 nm. In some embodiments the hollow capsule structure has a hollow macropore with a macropore diameter ranging from about 100 nm to about 5 μm. In some embodiments the nanopore diameter and the hollow macropore diameter have a ratio ranging from about 1:1 to about 1:200. In some embodiments the shell further includes a void with a void diameter of about 90% to about 95% of that of a nanopore. In some embodiments the hollow capsule structure has a surface area ranging from about 500 m²/g to 2000 m²/g. In some embodiments the hollow capsule structure further includes a material selected from the group consisting of carbon, a polymer and an inorganic metal oxide.

In another aspect a membrane-electrode assembly for a fuel cell includes an anode, a cathode, a polymer electrolyte membrane positioned between the anode and the cathode, and a hollow capsule structure including a shell having nanopores therein, the nanopores configured to function as a catalyst carrier, the hollow capsule structure disposed within the anode or the cathode. In some embodiments the nanopores are spherical.

In another aspect a method of preparing a hollow capsule structure includes providing one or more macropore particles, absorbing a cationic polymer in the one or more macropore particles, attaching a layer of nanopore particles on the macropore particles to form a hollow capsule structure template, firing the hollow capsule structure template to remove the cationic polymer and injecting a precursor into an opening of the hollow capsule structure template.

In some embodiments the macropore or the nanopore particles include a polymer including polystyrene, polyalkyl(meth)acrylate, a copolymer thereof or a macroemulsion polymer bead. In some embodiments the macropore or the nanopore particles include an inorganic oxide particle or a metal particle. In some embodiments the inorganic oxide particle includes an element selected from the group consisting of Si, Al, Zr, Ti and Sn. In some embodiments the metal particle includes an element selected from the group consisting of copper, silver and gold. In some embodiments the macropore particles have a macropore diameter ranging from about 100 nm to about 5 μm. In some embodiments the nanopore particles have nanopore diameter ranging from about 5 nm to about 100 nm. In some embodiments the method of preparing a hollow capsule structure further includes preparing the cationic polymer using a compound selected from the group consisting of diallyldialkylammonium halide, acryloxy alkylammonium halide, methacryloxy alkylammonium halide, vinyl aryl alkylammonium halide and 3-acrylamido-3-alkyl ammonium halide.

In some embodiments attaching a layer of the nanopore particles to the macropore particles includes a self-assembling method. In some embodiments firing the hollow capsule structure template includes firing at a temperature ranging from about 450 to about 700° C. In some embodiments the precursor is selected from the group consisting of a carbon precursor, a polymer precursor and an inorganic metallic precursor. In some embodiments injecting a precursor into an opening includes injecting the precursor in a form of a liquid or a vapor. In some embodiments the method of preparing a hollow capsule structure further includes removing the macropore particles or the nanopore particles by etching with an acid or a base or by firing. In some embodiments the method of preparing a hollow capsule structure further includes carbonizing the hollow capsule structure template after injecting the precursor.

In another aspect a hollow capsule structure has excellent electronic conductivity and a large specific surface area. In some embodiments the hollow capsule structure is configured to perform mass-transfer due to a capillary phenomenon among the nanopores in the shell and the macro-sized hollow space. In some embodiments the hollow capsule structure can be widely used in various areas such as for a catalyst carrier, an active material, a conductive agent, a separator, a deodorizer, a purifier, an adsorption agent, a material for a display emitter layer, a filter, and the like.

### BRIEF DESCRIPTION OF THE DRAWINGS

An apparatus according to some of the described embodiments can have several aspects, no single one of which necessarily is solely responsible for the desirable attributes of the apparatus. After considering this discussion, and particularly after reading the section entitled “Detailed Description” one will understand how the features of this invention provide advantages that include the ability to make and use a hollow capsule structure and a method of preparing the same.

FIG. 1 is a flowchart showing a process of preparing a hollow capsule structure according to one embodiment of the present disclosure.

FIG. 2A shows a photograph of a nano-capsule structure template including macro-sized silica and a nano-sized silica layer formed thereon according to Example 1.

FIG. 2B shows a photograph of a hollow nano-capsule structure template including macro-sized silica and two nano-sized silica layers formed thereon according to Example 2.

FIG. 2C shows a photograph of a hollow nano-capsule structure template including macro-sized silica and three nano-sized silica layers formed thereon according to Example 3.

FIG. 3A shows a photograph of a hollow capsule structure according to Example 3 taken with a transmission electronic microscope.

FIG. 3B shows a photograph of a hollow capsule structure according to Example 3 taken with a transmission electronic microscope.

FIG. 3C shows a photograph of a hollow capsule structure according to Example 3 taken with a transmission electronic microscope.

FIG. 3D shows a photograph of a hollow capsule structure according to Example 3 taken with a transmission electronic microscope.

FIG. 3E shows a photograph of a hollow capsule structure according to Example 3 taken with a transmission electronic microscope.

FIG. 3F shows a photograph of a hollow capsule structure according to Example 3 taken with a transmission electronic microscope.

FIG. 4 is a graph showing catalyst activities of Comparative Examples 2 and 3.

### DETAILED DESCRIPTION OF CERTAIN INVENTIVE EMBODIMENTS

As will be appreciated, the following detailed description is directed to certain specific embodiments of the invention. However, the invention can be embodied in a multitude of different ways. The present disclosure relates to a hollow capsule structure includes a shell having spherical nanopores therein. In some embodiments a nanopore diameter ranges from about 5 nm to about 100 nm. In some embodiments a hollow macropore has a macropore diameter ranging from about 100 nm to about 5 μm. In some embodiments a ratio of the nanopore diameter and the hollow macropore diameter is from about 1:1 to about 1:200. Hereinafter, these and other embodiments are described in more detail.

In this specification, “a porous material” is defined as a material with pores. Herein, “a micropore” has a micropore diameter of less than about 2 nm, “a macropore” has a macropore diameter of about 50 nm or more, and “a nanopore” has a nanopore diameter ranging from about 2 nm to about 50 nm.

Recently, there has been research on various synthesis methods of porous carbon materials. For example, a new method of synthesizing a macro-porous carbon material with a regular and uniform size includes injecting a precursor such as a carbohydrate or a polymer monomer into a spherical colloid crystal mold laminated with silica particles for polymerization and carbonization, and then melting the mold for removal. See, for example, A. A. Zajhidov, R. H. Baughman, Z. Iqubal, C. Cui, I. Khayrullin, S. O. Dantas, J. Matri and V. G. Ralchenko, Science 1998, 282, 897; J.-S. Yu, S. B. Yoon and G. S. Chai, Carbon 2001, 39 9, 1442-1446; J.-S. Yu, S. J. Lee and S. B. Yoon, Mol. Cryst. Liq. Cryst., 2001, 371, 107-110, each of which his hereby incorporated by reference in its entirety. However, the porous carbon material prepared according to the above method did not have a uniform mesopore in the shell or wall. In addition, when prepared as a double porous material including a uniform channel-shaped pore in the shell with a hollow space inside itself, the shell pore may have a size of 10 nm less. The shell pore may also limit the apparatus both for mass transfer and as a supporter.

Therefore, the present disclosure provides a hollow capsule structure. The hollow capsule structure may be fabricated using template particles including macro-sized particles and nano-sized particles formed as double layers thereon. This method has an advantage of easily controlling a surface area of the hollow capsule structure. In addition, when the hollow capsule structure is fabricated using in this method, the hollow capsule structure may have both excellent conductivity and a large specific surface area. With both excellent conductivity and a large specific surface area the hollow capsule structure may be used together with a fuel cell catalyst supporter, an active material or a conductive agent for a lithium secondary battery, a separator, a deodorizer, a purifier, an adsorption agent, a material for a display emitter layer, a filter and the like.

According to one aspect a hollow capsule structure includes a shell including spherical nanopores. In some embodiments the hollow capsule structure includes a hollow space with a macro-size pore diameter in its center. In some embodiments the macro-size pore diameter ranges from about 100 nm to about 5 μm. According to another embodiment, the pore diameter may be in a range of about 300 nm to about 2 μm. When a hollow capsule structure has a pore diameter within the above size range, it is easy to attach nanopore particles on the surface of a macropore particle.

In some embodiments the nanopores in the shell have a spherical shape. When a hollow capsule structure is used as a supporter, the spherical nanopores can be more easily supported than linear nanopores and can thereafter efficiently perform mass transfer after being supported.

In some embodiments the nanopores have a pore diameter ranging from about 5 to about 100 nm. In another embodiment, they may have a pore diameter ranging from about 10 to about 100 nm, but according to still another embodiment, they may have a pore diameter ranging from about 15 to about 100 nm or from about 20 to about 100 nm. When the pores have a diameter within the above range, the pores may not be clogged and can easily transfer mass due to a capillary phenomenon. In addition, in some embodiments the nanopore diameter in the shell and the hollow macropore diameter may have a pore size ratio ranging from about 1:1 to about 1:200. In another embodiment, they may have a pore size ratio ranging from about 1:3 to about 1:100. When they have one of the above pore size ratios, a plurality of spherical nanopores are easily formed.

In some embodiments the shell including the nanopores can be a single layer or multi-layers. When the shell is formed as multi-layers, it may have 2 to 5 layers, but in another embodiment, it may have 2 to 4 layers. When it has more than 5 layers, the capsule may have an inappropriate network. In some embodiments when a hollow capsule structure includes the hollow space and the nanopores, it may have a large specific surface area and thereby excellent adsorption and detachment effects. In particular, the hollow capsule structure may have a specific surface area ranging from about 500 m²/g to about 2000 m²/g. In another embodiment, it may have a specific surface area ranging from about 700 m²/g to about 1800 m²/g.

In some embodiments the hollow space is mutually connected with the nanopores in the shell, forming a three dimensional network and thereby providing excellent electronic conductivity. In some embodiments the nanopores include a void with a pore diameter of several nanometers. In particular, the void may have a pore size of about 90% to about 95% of that of a nanopore. The void may have a pore diameter of less than about 10 nm, but in another embodiment, it may have a pore diameter ranging from about 2 nm to about 8 nm.

The hollow capsule structure may be selected from the group consisting of carbon, a polymer material, and an inorganic oxide. In some embodiments the polymer material is obtained by polymerization of a monomer selected from the group consisting of divinylbezene, acrylonitrile, vinyl chloride, vinylacetate, styrene, (meth)acrylate, alkyl(meth)acrylate, ethyleneglycol dialkyl(meth)acrylate, urea, melamine, CR1R2=CR3R4 (wherein R1 to R4 are the same or independently selected from the group consisting of hydrogen, an alkyl, and an aryl, and the alkyl is a C1 to C6 alkyl and the aryl is a C6 to C12 aryl), phenol-formaldehyde, phenol, furfuryl alcohol, resorcinol-formaldehyde (RF), aldehyde, sucrose, glucose, xylose, and combinations thereof. In some embodiments the polymer material is a conductive polymer selected from the group consisting of polyaniline, polypyrrol, polyacetylene, polyacene, polythiophene, polyalkylthiophene, poly(p-phenylene), polyphenylene, polyphenylene sulfide, polyphenylenevinylene, polyfuran, polyacetylene, polyselenophene, polyisothianaphthene, polythiophenevinylene, polyperinaphthalene, polyanthracene, polynaphthalene, polyazulene, and copolymers thereof. The inorganic metal oxide may be an oxide selected from the group consisting of Al, Zr, Ti, Sn, and combinations thereof.

According to some embodiments of the present invention, a hollow capsule structure can be applied to a catalyst supporter, a supporter for forming carbon nanotubes, an active material, a conductive agent, a separator, a deodorizer, a purifier, an absorption agent, a material for forming a display emitter layer and a filter.

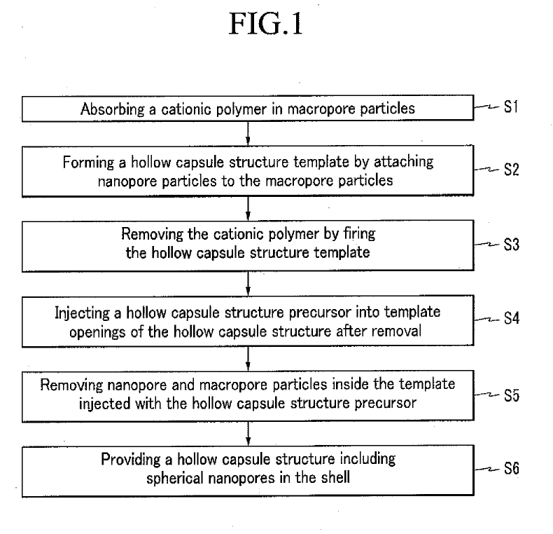

FIG. 1 is a flowchart showing a method of preparing a hollow capsule structure according to an embodiment of the present invention.

Referring to FIG. 1, the hollow capsule structure is prepared by: absorbing a cationic polymer in macropore particles (S1); forming a hollow capsule structure template by attaching nanopore particles to the macropore particles (S2); removing the cationic polymer by firing the hollow capsule structure template (S3); injecting a hollow capsule structure precursor into template openings of the hollow capsule structure after the removal (S4); removing nanopore and macropore particles inside the template injected with the hollow capsule structure precursor (S5); and providing a hollow capsule structure including spherical nanopores in the shell (S6). Hereinafter, each step will be more specifically explained.

First, a cationic polymer is absorbed in macropore particles (S1). In some embodiments the macropore particles include any material with no limit as long as it can be removed through etching with an acid or base or by physically heat-treating with fire. In particular, the material that can be removed with heat-treatment may include a polymer or a macroemulsion polymer bead including a polyalkyl(meth)acrylate such as polystyrene and polymethyl(meth)acrylate, and a copolymer thereof. In addition, the material that can be removed with an acid or base may include an inorganic oxide including an element selected from the group consisting of Si, Al, Zr, Ti, Sn, and combinations thereof, and a spherical metal such as copper, silver, gold, and combinations thereof.

The macropore particles form a hollow space in a final hollow capsule structure and can have various sizes depending on the hollow space size. In particular, it may have a size ranging from about 100 nm to about 5 μm. In another embodiment, it may have a size ranging from about 300 nm to about 2 μm. When macropore particles have the above size, the finally-prepared hollow capsule structure can have a hollow space with a large surface area per unit weight and through which it can easily perform mass transfer.

In some embodiments the cationic polymer is obtained from a monomer selected from the group consisting of diallyldialkylammonium halide, acryloxy alkylammonium halide, methacryloxyalkylammonium halide, vinylaryl alkylammonium halide, 3-acrylamido-3-alkyl ammonium halide, and mixtures thereof. In some embodiments the cationic polymer is obtained from a monomer selected from the group consisting of diallyldialkylammonium halide, acryloxyethyl trimethylammonium chloride, methacryloxyethyltrimethylammonium chloride, vinylbenzyltrimethylammonium chloride, 3-acrylamido-3-methylbutyl trimethylammonium chloride, and mixtures thereof. The cationic polymer surface-treats macropore particles so that the macropore particles have a positive (+) charge on the surface thereof, and thereby nanopore particles can be easily attached thereon.

The absorption of the cationic polymer in macropore particles includes a common surface treatment. In some embodiments the surface treatment includes coating, impregnation, and the like. In some embodiments the impregnation method is preferred. The impregnation method can be performed for coating or surface-reforming by dipping macropore particles in an aqueous solution or an organic solution. A negative macro-material is dipped in a cationic polymer solution and thereby changed to positive, so that the macro material can easily absorb a negative nano-material.

Next, a hollow capsule structure template is formed by attaching nanopore particles to the macropore particles absorbing the cationic polymer (S2). In some embodiments the nanopore particles include any material that can be removed through etching with an acid or base or heat-treatment by firing. In some embodiments the nanopore particles form nanopores in the shell of a finally-prepared hollow capsule structure and have a particle size ranging from about 5 nm to about 100 nm. In some embodiments the nanopore particles have a particle size ranging from about 15 to about 100 nm or from about 20 to about 100 nm. When nanopore particles have a pore diameter within the above range, they can form nanopores with a pore size within the range in a hollow capsule structure. Accordingly, they can have a large specific surface area and may not be clogged, and can easily transfer mass due to the capillary phenomenon.

The attachment method of nanopore particles to the macropore particles surface-treated with the cationic polymer may include a self-assembling method. For example, in some embodiments macropore particles surface-treated with a cationic polymer are centrifuged to remove a dispersion medium and gain the treated macropore particles. Then, the macropore particles are dispersed in a dispersion medium, and nanopore particles are added thereto. The resulting product is sufficiently agitated, and then centrifuged. The acquired particles are dried. Herein, it can be also additionally treated with ultrasonic waves for uniform mixture.

In some embodiments the absorption of a cationic polymer in macropore particles (S1) and the attachment of nanopore particles (S2) are repeated to form a plurality of nanopore particle layers.

Then, the hollow capsule structure template is fired to remove the cationic polymer (S3). In some embodiments the firing is performed at a temperature ranging from about 450° C. to about 700° C. In another embodiment, it may be performed at a temperature ranging from about 550° C. to about 600° C. When the firing is performed within the above temperature range, the cationic polymer cannot remain but can be efficiently removed in a short time. When the cationic polymer is not removed but remains, it can work as impurities and thereby transform the terminal on the surface of carbon. In addition, in some embodiments the firing is performed under an inert gas atmosphere such as with nitrogen, argon, and the like.

Next, a hollow capsule structure precursor is injected into openings of the hollow capsule structure, after the cationic polymer is removed (S4). In some embodiments the injection of the hollow capsule structure precursor is performed in a liquid or vapor method. In some embodiments the liquid method includes a sedimentation method, a centrifugation method, a filtration method, and the like. In particular, a template can be dipped in a liquid precursor solution. When the precursor is a liquid, a template is directly dipped therein. When it is a solid, it may need a solvent such as quinoline, toluene, alcohols, ketones, and combinations thereof. In addition, the vapor method may be performed under vacuum or by firing in a reflux system, but is not limited thereto. In particular, a solid-phased precursor material may be heated to be injected into a template in vapor. For example, when a polymer precursor is reacted under an acidic catalyst, it is heated beyond a boiling point for polymerization in which its gas is attached on the surface of the acidic catalyst, and thereby replaces it with acid.

In some embodiments the hollow capsule structure precursor includes a carbon precursor, a polymer precursor or an inorganic metal precursor. In some embodiments the carbon precursor includes coal tar pitch, petroleum pitch or mixtures thereof. When the carbon precursor is used, a template injected with a carbon precursor may be optionally carbonized before removing nanopore particles and macropore particles in the template. Herein, the carbonization may be performed at a temperature ranging from about 700° C. to about 3000° C. for about 3 hours to about 20 hours. In another embodiment, it may be performed at a temperature ranging from about 800° C. to about 1500° C. for about 5 hours to about 15 hours. Within the temperature and time range, a hollow capsule template may have increased electronic conductivity and carbon property. However, when the reaction is performed out of the temperature and time range, carbon may not be formed.

In some embodiments the polymer precursor is a material capable of forming graphite-like carbon through a carbonization reaction. Examples of the polymer precursor include one selected from the group consisting of divinylbezene, acrylonitrile, vinyl chloride, vinyl acetate, styrene, (meth)acrylate, alkyl(meth)acrylate, ethyleneglycol dialkyl(meth)acrylate, urea, melamine, CR1R2=CR3R4 (wherein R1 to R4 are the same or independently selected from the group consisting of hydrogen, an alkyl, and an aryl, the alkyl is a C1 to C6 alkyl, and the aryl is a C6 to C12 aryl), phenol-formaldehyde, phenol, furfuryl alcohol, resorcinol-formaldehyde (RF), aldehyde, sucrose, glucose, xylose, a monomer for forming a conductive polymer, and combinations thereof. The monomer for forming a conductive polymer may be any material being capable of forming an electrically conductive polymer, such as pyrrol and aniline. In some embodiments the conductive polymer includes polyaniline, polypyrrol, polyacetylene, polyacene, polythiophene, polyalkylthiophene, poly(p-phenylene), polyphenylene, polyphenylene sulfide, polyphenylenevinylene, polyfuran, polyacetylene, polyselenophene, polyisothianaphthene, polythiophenevinylene, polyperinaphthalene, polyanthracene, polynaphthalene, polyazulene, and so on. In some embodiments the polymer precursor is polymerized after the injection.

When the polymer precursor is selected from the group consisting of phenol-formaldehyde, phenol, furfuryl alcohol, resorcinol-formaldehyde (RF), aldehyde, sucrose, glucose, xylose, and combinations thereof, an initiator such as an acid catalyst may be further used. In some embodiments the acid catalyst is selected from the group consisting of sulfuric acid, hydrochloric acid and nitric acid.

In some embodiments the monomer is mixed with an initiator in a mole ratio ranging from about 15:1 to about 35:1. In other embodiments, the monomer is mixed with an initiator in a mole ratio ranging from about 20:1 to about 25:1. Within the above range, a polymerization reaction proceeds in a mild condition, acquiring a product with high purity. Out of the range, and in particular without an initiator, the polymerization may not occur.

When an initiator is added to the monomer, a polymer is produced through the additional polymerization. The additional polymerization reaction may be performed in an optimal method depending on each compound. The polymerization can be performed with heat-treatment at a temperature ranging from about 60° C. to about 90° C. for about 3 hours to about 30 hours, but is not limited thereto. The polymerization within the above temperature and time can increase a yield rate and purity of a product. In addition, the polymerization of a monomer may occur on the surface of a pore template, and thereby forms a pore of a carbon structure. In addition, when the polymer precursor is used, carbonization may be optionally performed after the polymerization, before removing the macropore particles.

In some embodiments disclosed herein, the carbonization is performed at a temperature ranging from about 700° C. to about 3000° C. for about 3 hours to about 20 hours. In another embodiment, it may be performed at a temperature ranging from about 800° C. to about 1500° C. for about 5 hours to about 15 hours. Within the temperature and time range, a hollow capsule template may have increased electronic conductivity and carbon property. However, when the reaction is performed out of the temperature and time ranges, carbon may not be formed. In addition, in some embodiments the temperature is increased at a speed of about 1° C./min to about 20° C./min. In other embodiments, the temperature is increased at a speed of about 1° C./min to about 10° C./min. When heated within the temperature range, a polymer may have minimal transformation of its terminal but an increased yield rate and purity of carbon.

In some embodiments the inorganic metal precursor includes a metal selected from the group consisting of Al, Zr, Ti, Sn, and combinations thereof. In some embodiments the inorganic metal precursor includes a halide such as TiCl₂, an oxide, and the like.

The inorganic metal precursor may not be injected into a template but instead is dissolved in water or a lower alcohol with 1 to 6 carbons. Accordingly, the inorganic metal precursor turns into an oxide including an inorganic metal in a template.

Then, the macropore and nanopore particles are removed from the hollow capsule structure template injected with a precursor (S5), preparing a hollow capsule structure including spherical nanopores in the shell (S6). In some embodiments the nanopore or macropore particles are removed by etching with a material that can dissolve the nanopore or macropore particles or through physical firing. In some embodiments the etching method is performed with a material selected from the group consisting of HF, NaOH, KOH, and combinations thereof. The firing process may be performed at a temperature ranging from about 450° C. to about 700° C. In another embodiment, it may be performed at a temperature ranging from about 550° C. to about 600° C. When the firing is performed within the temperature range, the nanopore or macropore particles may not remain but can be efficiently removed in a short time.

After removal of the nanopore and macropore particles, graphitization may be optionally performed. The graphitization may be performed at a temperature ranging from about 2300° C. to about 3000° C. In another embodiment, it may be performed at a temperature ranging from about 2300° C. to about 2600° C. The graphitization may increase the carbon property and improve electronic conductivity and performance as a carbon structure, and can thereby be applied in various ways.

The method of preparing a hollow capsule structure can regulate a nanopore size and the number of and thickness of shells, and thereby the surface area. As a result, in some embodiments the hollow capsule structure has excellent electronic conductivity and a large specific surface area. In some embodiments the hollow capsule structure is configured to easily perform mass transfer due to the capillary phenomenon between the macro-sized hollow space and nanopores in the shell. Therefore, the hollow capsule structure can be variously applied to a catalyst supporter for a fuel cell, a supporter for growing carbon nanotubes, an active material for a lithium secondary battery, a conductive agent, a separator, a deodorizer, a purifier, an adsorption agent, a material for a display emitter layer, a filter, and the like.

According to another aspect, a fuel cell catalyst includes a hollow capsule structure. In some embodiments the fuel cell catalyst includes a hollow capsule structure and an active material supported by the hollow capsule structure. In some embodiments the hollow capsule structure may be the same as described above.

The active material may include any catalyst that can perform a fuel cell reaction, such as a platinum-based catalyst. The platinum-based catalyst may include at least one selected from the group consisting of platinum, ruthenium, osmium, platinum-ruthenium alloys, platinum-osmium alloys, platinum-palladium alloys and platinum-M alloys (where M is a transition element selected from the group consisting of Ga, Ti, V, Cr, Mn, Fe, Co, Ni, Cu, Zn, Sn, Mo, W, Rh and Ru). More specifically, non-limiting examples of the platinum-based catalyst may be selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and mixtures thereof.

According to another aspect, a membrane-electrode assembly includes an electrode. In some embodiments the membrane-electrode assembly includes an anode, a cathode, and a polymer electrolyte membrane interposed between the cathode and the anode. At least one of the anode and cathode includes the catalyst. In some embodiments the cathode and anode include an electrode substrate and a catalyst layer. In some embodiments the catalyst layer includes the catalyst described above.

The catalyst layer may further include a binder resin to improve its adherence and proton transfer properties. The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the polymer include at least one proton conductive polymer selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole) and poly (2,5-benzimidazole).

The binder resins may be used singularly or in combination. In some embodiments the binder resins are used along with non-conductive polymers to improve adherence with the polymer electrolyte membrane. In some embodiments the binder resins are used in a controlled amount according to their purposes.

Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol and combinations thereof.

In some embodiments the electrode substrate is configured to support catalyst layers of the membrane-electrode assembly and provide a path for transferring the fuel and the oxidant to catalyst layers in a diffusion manner. In some embodiments the electrode substrate includes a conductive substrate formed from a material such as carbon paper, carbon cloth, carbon felt, or a metal cloth (a porous film composed of a metal fiber or a metal film disposed on a surface of a cloth composed of polymer fibers). The conductive plate is not limited thereto.

In some embodiments the electrode substrate is treated with a fluorine-based resin to be water-repellent, which can prevent deterioration of reactant diffusion efficiency due to water generated during a fuel cell operation. In some embodiments the fluorine-based resin includes polyvinylidene fluoride, polytetrafluoroethylene, fluorinated ethylene propylene, polychlorotrifluoro ethylene or copolymers thereof, but is not limited thereto.

In addition, in some embodiments a microporous layer (MPL) is added between the aforementioned electrode substrates to increase reactant diffusion effects. In some embodiments the microporous layer includes conductive powders with a particular particle diameter. In some embodiments the conductive material includes, but is not limited to, carbon powder, carbon black, acetylene black, activated carbon, carbon fiber, fullerene, nano-carbon or combinations thereof. In some embodiments the nano-carbon includes a material such as carbon nanotubes, carbon nanofiber, carbon nanowire, carbon nanohorns, carbon nanorings or combinations thereof. In some embodiments the microporous layer is formed by coating a composition including a conductive powder, a binder, and a solvent on the electrode substrate. In some embodiments the binder includes, but is not limited to, polytetrafluoroethylene, polyvinylidenefluoride, polyvinylalcohol, celluloseacetate, and so on. In some embodiments the solvent includes, but is not limited to, an alcohol such as ethanol, isopropyl alcohol, n-propyl alcohol, butanol, and so on, water, dimethyl acetamide, dimethyl sulfoxide, and N-methylpyrrolidone. In some embodiments the coating method includes, but is not limited to, screen printing, spray coating, doctor blade methods, gravure coating, dip coating, silk screening, painting, and so on, depending on the viscosity of the composition.

In some embodiments the polymer electrolyte membrane includes a proton conductive polymer for transferring protons from an anode to a cathode. In some embodiments the proton conductive polymer includes a polymer resin having a cation exchange group selected from the group consisting of a sulfonic acid group, a carboxylic acid group, a phosphoric acid group, a phosphonic acid group and derivatives thereof, at its side chain.

Non-limiting examples of the polymer resin include at least one selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers and polyphenylquinoxaline-based polymers. In one embodiment, the proton conductive polymer is at least one selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole).

The hydrogen (H) in the proton conductive group of the proton conductive polymer can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used, respectively. When the H is substituted with K, Li, or Cs, suitable compounds for the substitutions may be used. Since such a substitution is known to this art, a detailed description thereof is omitted.

The following examples illustrate various embodiments of the present disclosure in more detail. It will be understood by one of skill in the art that the attached claims are not limited to any one or group of the embodiments illustrated in the following examples.

### EXAMPLE 1

700 ml of an aqueous dispersion solution in which SiO₂ particles with an average particle diameter of 500 nm were dispersed was surface-treated with polydiallyldimethylammonium chloride as a cationic polymer. Then, it was mixed with 12 ml of a colloidal dispersion solution including SiO₂ with an average particle diameter of about 20 nm in a concentration of 40% to prepare a SiO₂ hollow nano-capsule structure template on the surface of the cationic polymer. The template was heat-treated at a temperature of about 550° C. for 5 hours to remove the cationic polymer.

Then, 4 ml of divinyl benzene was mixed with 0.1845 g of azobisisobutyronitrile to prepare a polymer precursor solution. The polymer precursor solution was mixed with 2 g of the template, so that the polymer precursor solution could fill the openings among the SiO2 particles for polymerization of the polymer. The polymerized polymer was carbonized at 1000° C. for 7 hours under argon gas. The carbide was added to 100 ml of a HF solution to dissolve the remaining cationic polymer and SiO₂ to prepare a nano-capsule structure including a hollow space and a shell including nanopores with an average particle diameter of about 20 nm.

### EXAMPLE 2

700 ml of an aqueous dispersion in which SiO₂ particles with an average particle diameter of 500 nm were dispersed was surface-treated with polydiallyldimethylammonium chloride as a cationic polymer. Then, it was mixed with 12 ml of a colloidal dispersion including SiO₂ with an average particle diameter of about 20 nm in a concentration of 40% to attach SiO₂ on the surface of the cationic polymer. The attachment process was repeated twice, preparing a hollow nano-capsule structure template including a double-layered shell. The template was heat-treated at 550° C. in a pipeline for 5 hours to remove the cationic polymer.

Next, 0.1845 g of azobisisobutyronitrile was mixed with 4 ml of divinyl benzene to prepare a polymer precursor solution. Then, 2 g of the template was put into the polymer precursor solution, so that the polymer precursor solution could fill openings among the SiO₂ particles through polymerization. The polymerized polymer was heated for carbonization at 1000° C. under argon gas for 7 hours. The prepared carbide was put in 100 ml of a HF solution to dissolve the remaining cationic polymer and SiO₂, preparing a hollow nano-capsule structure including hollow macropores with an average particle diameter of 500 nm and a shell including nanopores with an average particle diameter of about 20 nm.

### EXAMPLE 3

700 ml of an aqueous dispersion solution in which SiO₂ particles with an average particle diameter of 500 nm were dispersed was surface-treated with polydiallyldimethylammonium chloride as a cationic polymer. The resulting product was mixed with 12 ml of a colloidal dispersion solution including SiO₂ with an average particle diameter of about 20 nm in a concentration of 40% to attach SiO₂ on the surface of the cationic polymer. The attachment process was repeated three times, preparing a hollow nano-capsule structure template including a three-layered shell. The template was heat-treated at about 550° C. in a pipeline for 5 hours to remove the cationic polymer.

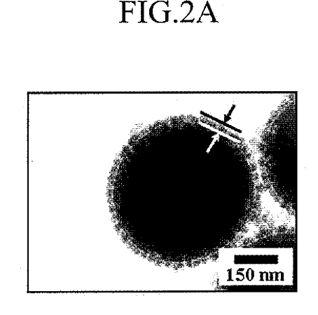

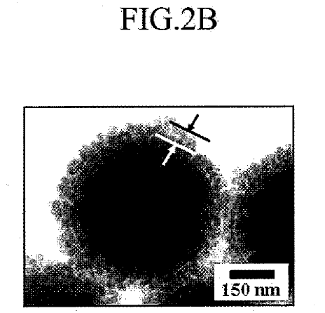

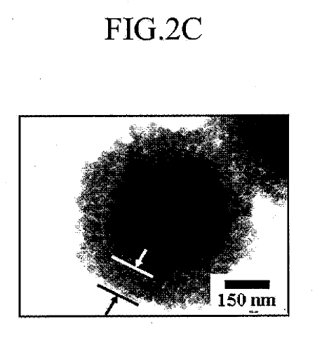

Next, 0.1845 g of azobisisobutyronitrile was mixed with 4 ml of divinyl benzene to prepare a polymer precursor solution. The polymer precursor solution was mixed with 2 g of the template, so that the polymer precursor solution could fill openings among SiO₂ particles through polymerization. Then, the polymerized polymer was heated for carbonization at 1000° C. under argon gas for 7 hours. The carbide was put into 100 ml of a HF solution to dissolve the remaining cationic polymer and SiO₂ to prepare a hollow nano-capsule structure including hollow macropores with an average particle diameter of 500 nm and a shell including nanopores with an average particle diameter of about 20 nm. The hollow nano-capsule structure template prepared by attaching nano-sized silica particles to macro-sized silica particles according to Examples 1 to 3 was examined with a scanning electronic microscope. The results are shown in FIGS. 2A to 2C.

FIG. 2A shows a photograph of a hollow nano-capsule structure template including macro-sized silica and one nano-sized silica layer formed thereon according to Example 1. FIG. 2B shows a photograph of a hollow nano-capsule structure template including two nano-silica layers according to Example 2. FIG. 2C is a photograph of a hollow nano-capsule structure template including three nano-sized silica layers according to Example 3.

As shown in FIGS. 2A to 2C, nano-sized silica layers were formed in plural on the surface of macro-sized silica.

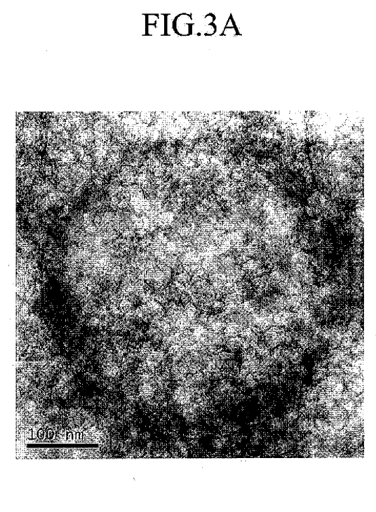

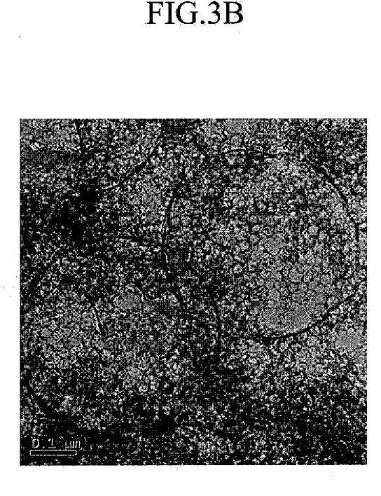

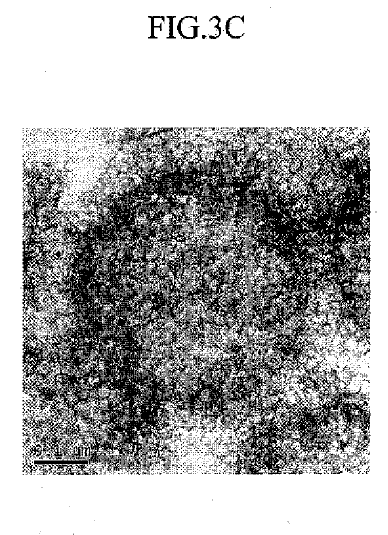

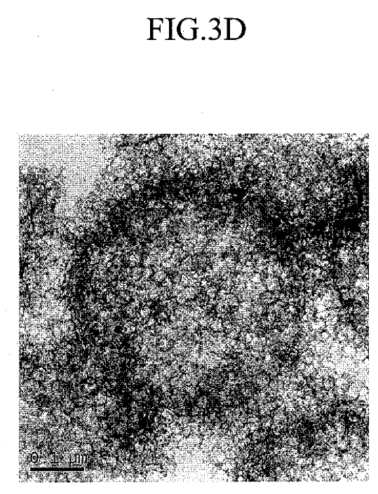

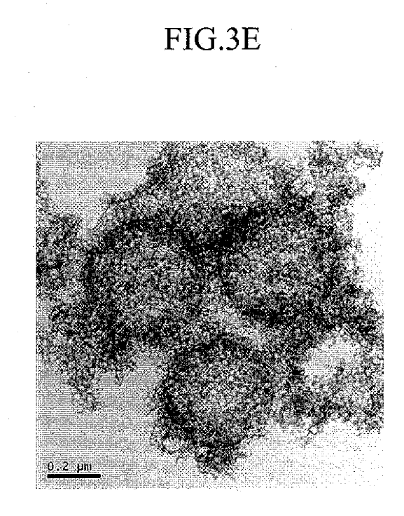

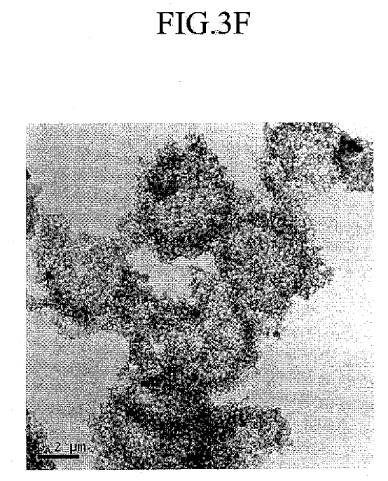

The hollow capsule structure of Example 3 was examined with a transmission electron microscope (TEM). The results are shown in FIGS. 3A to 3F.

As shown in FIGS. 3A to 3F, the hollow capsule structure included a macro-sized hollow macropore in the center and a shell surrounding the hollow macropore and including uniformly-sized nanopores.

### EXAMPLE 4

A hollow capsule structure template was prepared according to the same method as in Example 3 except for surface-treating 700 ml of a dispersion solution in which SiO₂ particles with an average particle diameter of 300 nm were dispersed, with polydiallydimethylammonium chloride as a cationic polymer, and then mixing the resulting product with 12 ml of a colloidal dispersion of SiO₂ with an average particle diameter of about 20 nm in a concentration of 40% to attach SiO₂ on the surface of the cationic polymer particles.

### COMPARATIVE EXAMPLE 1

4.72 mmol of octadecyltrimethoxysilane (C18-TMS) was mixed with 4.7 mmol of tetraethylorthosilicate (TEOS). The mixture was added to a dispersion solution in which 1.5 g of spherical silica particles with a diameter of about 133 nm were dispersed. The resulting product was heat-treated at about 550° C. in a pipeline for 5 hours to remove the C18-TMS, synthesizing a hollow silica template particle with a 3.8 nm mesoporous shell.

The hollow silica particle was used as a mold. Then, divinyl benzene as a polymer precursor was mixed with an azobisisobutyronitrile radical initiator. The mixture was injected into the mold and then polymerized at 70° C. for one day, preparing a divinyl benzene polymer-silica composite material. Herein, the mole ratio of the polymer monomer and the radical initiator was 25:1. In addition, a part of the divinyl benzene polymer-silica composite was heated for carbonization at 1000° C. under a nitrogen atmosphere for 7 hours, preparing a carbon-silica composite. Then, a HF aqueous solution was added to the carbon-silica composite to remove the silica mold and to separate a porous polymer and a carbon capsule. Then, the porous polymer and carbon capsule was dried.

Upon close examination of the carbon capsule, the carbon capsule was found to include a 440 nm macropore in the center and 4.8 nm mesopores in the shell. In addition, the mesopores were irregularly distributed in the carbon capsule.

### EXAMPLE 5

### Preparation of a Catalyst

0.9544 g of H₂PtC₁₆ was dissolved in 80 ml of distilled water, preparing a metallic salt solution. Then, the metallic salt solution was added to a dispersion solution prepared by dispersing 0.1481 g of the hollow capsule structure of Example 3 as a catalyst supporter in 150 ml of distilled water. The mixed solution was diluted until a metallic salt having a 2 mM concentration in the entire solution was obtained. The solution was regulated to have pH of about 8.5 by using 20 wt % NaOH. Then, 40 ml of an aqueous solution prepared by dissolving 1.6 g of NaBH₄ as a reducing agent was added to the mixed solution for precipitation. When the mixed solution became clear on top, it was filtered several times with a 0.2 μm nylon filter. The filtered product was washed several times with distilled water and then dried at 80° C., preparing a Pt catalyst supported on a supporter. Herein, the Pt was supported in an amount of 60 wt % based on the entire weight of the catalyst.

### EXAMPLE 6

### Preparation of a Catalyst

A Pt catalyst was prepared according to the same method as in Example 5 except for using a hollow capsule structure as a catalyst supporter according to Example 4.

### COMPARATIVE EXAMPLE 2

### Preparation of a Catalyst

A Pt catalyst was prepared according to the same method as in Example 5 except for using a carbon capsule as a catalyst supporter according to Comparative Example 1.

### EXAMPLE 7

### Preparation of a Membrane-Electrode Assembly for a Fuel Cell

A Pt—Ru/C catalyst was prepared by supporting the hollow capsule structure in 2 mg/cm² of Pt—Ru black (Johnson Matthey Co.) according to Example 3. The Pt—Ru/C catalyst was mixed with distilled water, isopropylalcohol, and 5 wt % of a Nafion ionomer solution (Aldrich Co.) in a weight ratio of 1:1:10:1, preparing a composition for an anode catalyst layer. In addition, a Pt/C catalyst was prepared by supporting 2 mg/cm² of Pt black (Johnson Matthey Co.) in a hollow capsule structure according to Example 3. The Pt/C catalyst was mixed with distilled water, isopropylalcohol, and 5 wt % of a Nafion ionomer solution (Aldrich Co.) in a weight ratio of 1:1:10:1, preparing a composition for a cathode catalyst.

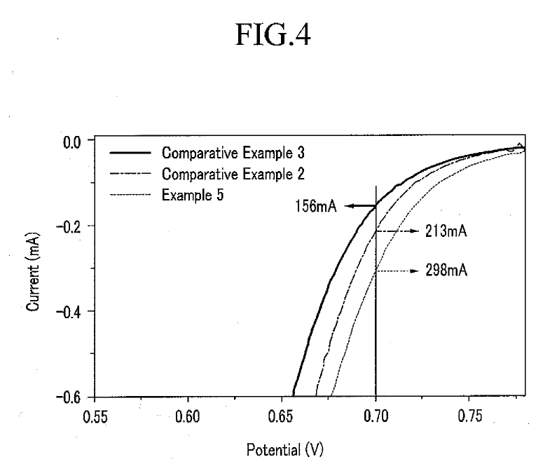

The compositions for anode/cathode catalyst layers were respectively coated on carbon papers treated with TEFLON (tetrafluoroethylene), preparing an anode and a cathode for a fuel cell. Next, a polymer electrolyte membrane (Nafion 115 Membrane, Dupont) was positioned between the anode and the cathode to prepare a membrane-electrode assembly for a fuel cell. Then, the Pt—Ru alloy catalysts according to Example 5 and Comparative Example 2 were evaluated regarding catalyst activity. The catalyst activity evaluation was performed by using a half-cell test. In addition, a commercial catalyst, Pt black (Johnson Matthey Co.) catalyst, was used as in Comparative Example 3 to evaluate catalyst efficiency. The result is shown in FIG. 4.

On the other hand, a reaction cell was prepared to include Ag/AgCl as a reference electrode, an electrode prepared by respectively coating the catalysts of Example 5 and Comparative Examples 2 and 3 on a carbon paper (1.5 cm×1.5 cm) in a loading amount of 2 mg/cm² as a working electrode, a platinum electrode (Pt gauze, 100 mesh, Aldrich) as a counter-electrode, and a 0.5M sulfuric acid solution as an electrolyte.

The reaction cell was measured regarding current characteristic as a base, changing a potential at a scan rate of 20 mV/s within a range of 350 mV to 1350 mV. In addition, the reaction cell was provided with 1.0M of a methanol solution to measure the current characteristic, changing its potential within a range of 350 mV to 1350 mV at a scan speed of 20 mV/s. The electrodes of Example 5 and Comparative Examples 2 and 3 were used as a working electrode. The results are shown in FIG. 4.

As shown in FIG. 4, a Pt catalyst of Example 5, including a hollow capsule structure as a catalyst supporter, respectively had 91% and 40% improved catalyst activity than a commercial Pt black catalyst of Comparative Example 3 and a Pt catalyst of Comparative Example 2 including a carbon capsule catalyst as a supporter. The reason that the hollow capsule structure of Example 3 had more improved catalyst activity than a carbon capsule catalyst supporter of Comparative Example 1 is that the hollow capsule structure of Example 3 not only includes spherical nanopores with a size of 5 nm to 100 nm but can also easily transfer mass due to the capillary phenomenon according to networks among the pores. On the other hand, the carbon capsule of Comparative Example 1 had too-small meso-pores with a size ranging from 2 nm to 5 nm and could not easily transfer mass due to channels of the capsule structure itself.

The foregoing description details certain embodiments of the invention. It will be appreciated, however, that no matter how detailed the foregoing appears in the text, the invention can be practiced in additional ways. It should also be noted that the use of particular terminology when describing certain features or aspects of the invention should not be taken to imply that the terminology is being re-defined herein to be restricted to include any specific characteristics of the features or aspects of the invention with which that terminology is associated. Further, numerous applications are possible for devices of the present disclosure. It will be appreciated by those skilled in the art that various modifications and changes may be made without departing from the scope of the invention. Such modifications and changes are intended to fall within the spirit and scope of the invention, as defined by the appended claims.

What is claimed is:

1. A hollow capsule structure comprising a shell having nanopores therein.

2. The hollow capsule structure of claim 1, wherein the nanopores comprise spherical nanopores.

3. The hollow capsule structure of claim 1, wherein a nanopore diameter ranges from about 5 nm to about 100 nm.

4. The hollow capsule structure of claim 3 further comprising a hollow macropore with a macropore diameter ranging from about 100 nm to about 5 μm.

5. The hollow capsule structure of claim 4, wherein a ratio of the nanopore diameter and the hollow macropore diameter is from about 1:1 to about 1:200.

6. The hollow capsule structure of claim 1, wherein the shell is multi-layers.

7. The hollow capsule structure of claim 1, wherein the shell further comprises a void, with a void diameter of about 90% to about 95% of that of a nanopore.

8. The hollow capsule structure of claim 1 having a surface area ranging from about 500 m²/g to about 2000 m²/g.

9. The hollow capsule structure of claim 1 further comprising a material selected from the group consisting of carbon, a polymer and an inorganic metal oxide.

10. The hollow capsule structure of claim 1, wherein the hollow capsule structure is applied to a catalyst supporter, a supporter for carbon nanotube growth, an active material, a conductive agent, a separator, a deodorizer, a purifier, an adsorption agent, a material for a display emitter layer, or a filter.

11. A fuel cell catalyst comprising:
a hollow capsule structure comprising a shell having nanopores therein; and
an active material disposed on the hollow capsule structure.

12. The fuel cell catalyst of claim 11, wherein the nanopores comprise spherical nanopores.

13. The fuel cell catalyst of claim 11, wherein the nanopores comprise a nanopore diameter ranging from about 5 nm to about 100 nm.

14. The fuel cell catalyst of claim 11, wherein the hollow capsule structure has a hollow macropore with a macropore diameter ranging from about 100 nm to about 5 μm.

15. The fuel cell catalyst of claim 11, wherein the hollow macropore diameter and the nanopore diameter have a ratio ranging from about 1:1 to about 1:200.

16. The fuel cell catalyst of claim 11, wherein the shell is multi-layers.

17. The fuel cell catalyst of claim 11, wherein the shell further comprises a void with a void diameter of about 90% to about 95% of that of a nanopore.

18. The fuel cell catalyst of claim 11, wherein the hollow capsule structure has a surface area ranging from about 500 m²/g to 2000 m²/g.

19. The fuel cell catalyst of claim 11, further comprising a material selected from the group consisting of carbon, a polymer and an inorganic metal oxide.

20. A membrane-electrode assembly for a fuel cell comprising:
an anode;
a cathode;
a polymer electrolyte membrane positioned between the anode and the cathode, and
a hollow capsule structure comprising a shell having nanopores therein, the nanopores configured to function as a catalyst carrier, the hollow capsule structure disposed within the anode or the cathode.

21. The membrane-electrode assembly of claim 20, wherein the nanopores are spherical.

22. A method of preparing a hollow capsule structure, comprising:
providing one or more macropore particles;
absorbing a cationic polymer in the one or more macropore particles;
attaching a layer of nanopore particles on the macropore particles to form a hollow capsule structure template;
firing the hollow capsule structure template to remove the cationic polymer; and
injecting a precursor into an opening of the hollow capsule structure template.

23. The method of claim 22, wherein the macropore or the nanopore particles comprise a polymer comprising polystyrene, polyalkyl(meth)acrylate, a copolymer thereof or a macroemulsion polymer bead.

24. The method of claim 22, wherein the macropore or the nanopore particles comprise an inorganic oxide particle or a metal particle.

25. The method of claim 24, wherein the inorganic oxide particle comprises an element selected from the group consisting of Si, Al, Zr, Ti and Sn.

26. The method of claim 24, wherein the metal particle comprises an element selected from the group consisting of copper, silver and gold.

27. The method of claim 22, wherein the macropore particles have a macropore diameter ranging from about 100 nm to about 5 μm.

28. The method of claim 22, wherein the nanopore particles have nanopore diameter ranging from about 5 nm to about 100 nm.

29. The method of claim 22 further comprising preparing the cationic polymer using a compound selected from the group consisting of diallyldialkylammonium halide, acryloxy alkylammonium halide, methacryloxy alkylammonium halide, vinyl aryl alkylammonium halide and 3-acrylamido-3-alkyl ammonium halide.

30. The method of claim 22 wherein attaching a layer of the nanopore particles to the macropore particles comprises a self-assembling method.

31. The method of claim 22, wherein firing the hollow capsule structure template comprises firing at a temperature ranging from about 450 to about 700° C.

32. The method of claim 22, wherein the precursor is selected from the group consisting of a carbon precursor, a polymer precursor and an inorganic metallic precursor.

33. The method of claim 22, wherein injecting a precursor into an opening comprises injecting the precursor in a form of a liquid or a vapor.

34. The method of claim 22 further comprising removing the macropore particles or the nanopore particles by etching with an acid or a base or by firing.

35. The method of claim 22 further comprising carbonizing the hollow capsule structure template after injecting the precursor.
